(19) United States
(12) Patent Application Publication
(10) Pub. No.: US 2009/0086695 A1
(43) Pub. Date: Apr. 2, 2009

(54) Mechanism for communication with multiple wireless video area networks

(76) Inventors: James P.K. Gilb, San Diego, CA (US); Jeffery M. Gilbert, Palo Alto, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/215,959

(22) Filed: Jun. 30, 2008

Related U.S. Application Data
(60) Provisional application No. 60/975,690, filed on Sep. 27, 2007.

(51) Int. Cl. H04W 92/02

(52) U.S. Cl. 370/338

(57) ABSTRACT

A device is disclosed having a first radio component to enable the device to communicate with devices in a first wireless network via a first wireless communication protocol and a second radio component to enable the device to communicate with devices in a second wireless network via a second wireless communication protocol.

This is a non provisional application based on the provisional application Ser. No. 60/975,690, filed Sep. 27, 2007, and claims priority thereof.

### FIELD OF INVENTION

An embodiment of the invention relates to wireless communication, and more specifically, to the transfer of multimedia data via wireless communication networks.

### BACKGROUND

WirelessHD is a wireless video area network (WVAN) specification that provides an interface for wireless high-definition transmission of HD video and audio signals for consumer electronics products. Devices implementing the WirelessHD specification typically include antenna technology that enables non line of sight (NLOS) operation with other devices, where NLOS is a radio channel or link having no visual line of sight (LOS) between an antenna of a transmitting device and an antenna of a receiving device.

For instance, a flat panel television may communicate with a digital video disc (DVD) player via NLOS operation to enable the DVD player to be placed in a location that is convenient and out of the way, as opposed to LOS operation that would require the DVD player to sit in plain view path of the television, resulting in the potential of communication between the devices becoming intermittently blocked by obstacles.

Ultra-low power devices may choose instead to use a line of sight (LOS) only protocol which is optimized for low power but has a line of site restriction as a result. There may be occasions where an NLOS device, such as the flat panel television, needs to temporarily operate with an LOS device (e.g., a camcorder, digital camera, etc.) to wirelessly download data to the television for display. In such an instance, the television would typically operate with such a device using short range LOS communication.

A problem exists, however, in that different types of radio architectures are implemented for LOS-only versus NLOS operation. This would prevent the flat panel device from having the capability with communicating with both the LOS protocol device and the NLOS protocol device.

Accordingly, what is desired is a combination device that can operate with both LOS-only and NLOS classes of devices.

### SUMMARY

According to one embodiment, a device is disclosed having a first radio component to enable the device to communicate with devices in a first wireless network, e.g., a video area network (WVAN) or a wireless personal area network (WPAN), via a first wireless communication protocol and a second radio component to enable the device to communicate with devices in a second wireless network via a second wireless communication protocol.

In one embodiment, the device transitions from communication with devices in the first network to communicate with devices in the second network and then returns to the first network after it has completed the communications with the devices in the first network. However in another embodiment, the device maintains communication with devices in the first network while also communicating with devices in the second network by reserving time in the first network, and communicating with devices in the second network during the time reservation in the first network.

### BRIEF DESCRIPTION OF THE DRAWINGS

The invention may be best understood by referring to the following description and accompanying drawings that are used to illustrate embodiments of the invention. In the drawings:

FIG. 1 is a block diagram of one embodiment of a communication system;

FIG. 2 is a block diagram of another embodiment of the communication system;

FIG. 3 is a diagram illustrating one embodiment for communication with LOS and NLOS networks; and

FIG. 4 is a diagram illustrating another embodiment for communication with LOS and NLOS networks.

### DETAILED DESCRIPTION

A mechanism for communication with multiple wireless networks is disclosed. According to one an embodiment, a combination device implements multiple radio components, each enabling the device to communicate with networks having different communication protocols. For example a first radio component enables the combination device to communicate with a first device operating in a first network via an NLOS protocol, while a second radio component enables the combination device to communicate with a second device operating in a second network via an LOS protocol.

In the following description, numerous details are set forth. It will be apparent, however, to one skilled in the art that embodiments of the present invention may be practiced without these specific details. In other instances, well-known structures, devices, and techniques have not been shown in detail, in order to avoid obscuring the understanding of the description. The description is thus to be regarded as illustrative instead of limiting.

Reference in the specification to “one embodiment” or “an embodiment” means that a particular feature, structure, or characteristic described in connection with the embodiment is included in at least an embodiment of the invention. The appearances of the phrase “in one embodiment” in various places in the specification are not necessarily all referring to the same embodiment.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

### An Example of a Communication System

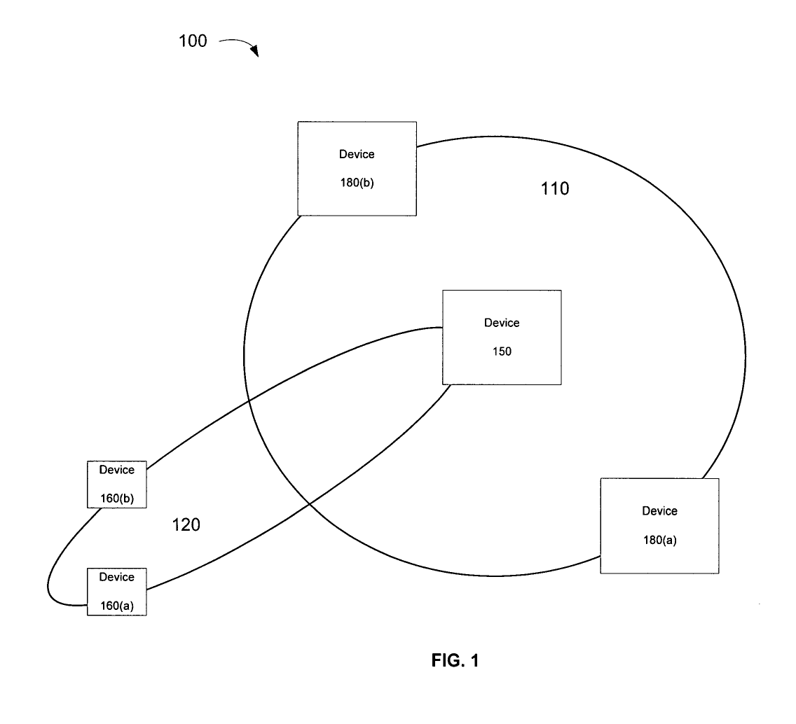

FIG. 1 is a block diagram of one embodiment of a communication system 100. Referring to FIG. 1, communication system 100 includes a network 110 and a network 120. In one embodiment, networks 110 and 120 are wireless networks, such as a WirelessHD network. However, in other embodiments, different types of wireless networks (e.g., WVAN or WPAN) may be implemented.

In a further embodiment, devices operating in network 110 communicate via an NLOS protocol, while devices in network 120 implement an LOS protocol. In yet another embodiment, devices in both networks 110 and 120 operate on the 60 GHz band. However, in other embodiments, one or both of the networks may operate at other frequency bands (e.g., 2.4 GHz band).

According to one embodiment, network 110 includes a device 150, as well as devices 180 (e.g., 180(a) and 180(b)). Device 150 is also included in network 120 along with a device 160. Device 160 may represent several devices 160(a) and 160(b). Devices 180 may include a DVD player and an audio-video receiver operating via NLOS protocols, while device 160 may be a digital camcorder operating with LOS protocols.

In one embodiment, device 150 is a combination device that supports both NLOS and LOS protocols, enabling communication with both devices 180 in network 110 and device 160 in network 120. In a further embodiment, device 150 is a flat panel television that is capable of displaying content received from the NLOS devices and LOS devices.

Although described above as a flat panel television, combination device 150 may be implemented as other types of devices (e.g., a set top box, digital video recorder (DVR), etc). Similarly, device 160 and devices 180 may, in other embodiments, be implemented as other types of devices.

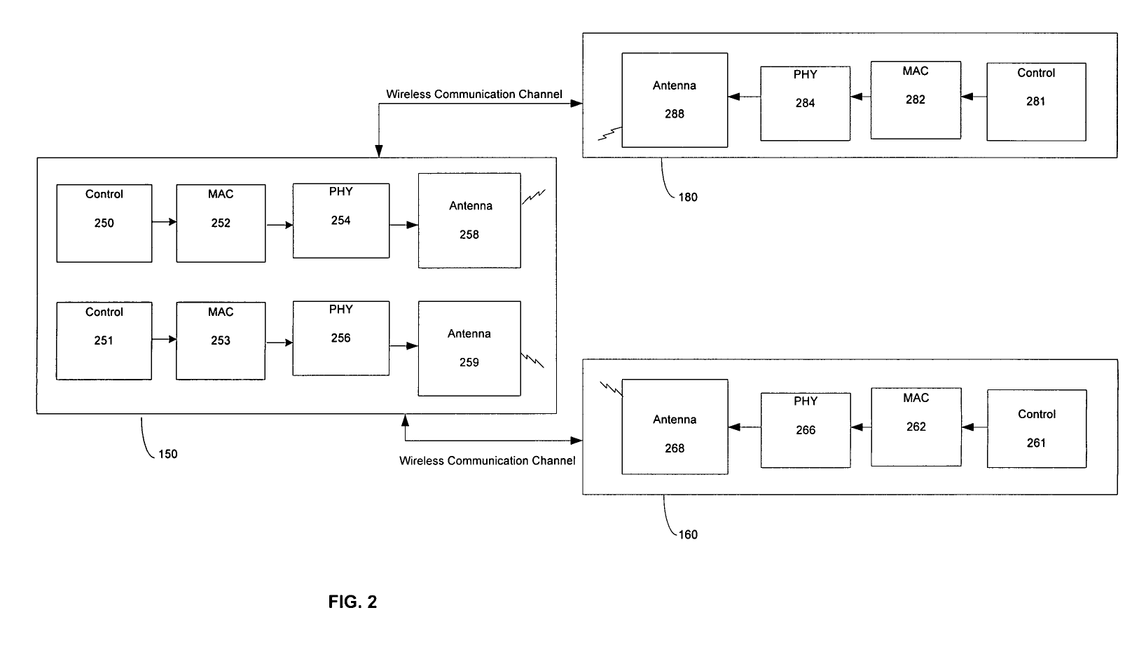

FIG. 2 is a block diagram of one embodiment of the communication system illustrating components of a device 150, a device 160 and a device 180. According to one embodiment, each device includes a radio component having a control module, a media access control (MAC) component, physical layer (PHY) component and one or more antennas.

Particularly, device 150 includes control modules 250 and 251, media access control (MAC) 252 and MAC 253, physical layer (PHY) 254 and PHY 256, antenna 258 and antenna 259. According to one embodiment, control module 250, MAC 252, PHY 254 and antenna 258 comprise NLOS radio components that are implemented to enable device 150 to wirelessly transfer data to and from wireless device 180 in network 110. Similarly, control module 251, MAC 253, PHY 254 and antenna 259 form LOS radio component that enable the wireless transfer of data to and from wireless device 160 via network 120.

Control modules 250 and 251 control the wireless transfer of data to devices 160 and 180, respectively. Particularly, each control module performs functions such as authentication and key generation for content protection, video format selection (e.g., resolution, color, depth, etc.), video and audio encode and decode, clock synchronization and service discovery.

In one embodiment, control module 250 and control module 251 communicate to perform synchronization between network 110 and network 120. In a further embodiment, the control modules are implemented to route data from one network to the other. In other embodiments, a single control module may be implemented to control the transfer of data to and among devices 160 and 180 in the networks.

MAC 252 and MAC 253 perform functions such as PHY channel selections; send/receive data, connection start/stop, bandwidth reservation, device discovery, shutdown/sleep, and authentication. In one embodiment, MAC 252 also performs scheduling of beamforming. PHY 254 and PHY 256 each pass channel assessment to MAC 252 and MAC 253, respectively, send/receive data, perform antenna control, verify header information, etc.

According to one embodiment, PHY 254 enables communication with NLOS devices using orthogonal frequency division multiplex (OFDM) signals. Note that in other embodiments, PHY 254 may also communicate with NLOS devices using single carrier signals. PHY 256 enables communication with the LOS devices via single carrier signals. Note that in other embodiments, PHY 256 may also communicate with the LOS devices via OFDM signals.

PHY 256 is coupled to antenna 259 which transmits and receives radio waves with device 160. Similarly, PHY 254 is coupled to phased array antenna 258 to communicate with a device 180. In one embodiment, antenna 258 comprises a radio frequency (RF) transmitter having a digitally controlled phased array antenna to transmit content to device 180 using adaptive beamforming that allows beam steering. However, in other embodiments, antenna 258 implements other types of steerable arrays, such as sectorized antennas.

Device 160 and device 180 also include a control module (261 and 281), a MAC (262 and 282), and a PHY (266 and 284). These components operate in a manner comparable to the analogous components described above with reference to device 150. For instance, the components within device 160 operate according to an LOS protocol to communicate with device 150 via antenna 268. Similarly, the device 180 components operate according to an NLOS protocol to communicate with device 150 via antenna 288.

### Network Hopping

According to one embodiment, device 150 communicates with both NLOS protocol devices and LOS protocol devices by hopping between network 110 and network 120. In such an embodiment, device 150 typically operates using the NLOS protocol while communicating in network 110. At periodic intervals device 150 will transition from network 110 to network 120 and operate according to the LOS protocol.

While operating in the LOS network 120, device 150 monitors network 120 for a message from a device (e.g., device 160). In one embodiment, combination device 150 transitions from network 110 to network 120 periodically with a time determined by application requirements for latency. For instance, an application may require that the transition occurs at a given periodicity (e.g., every 10 ms). In another embodiment, combination device 150 transitions from network 110 to network 120 to receive every beacon in both of the networks. In yet another embodiment, combination device 150 transitions for a subset of the beacons.

In another embodiment, device 150 transmits a signal announcing the presence of device 150 on network 120 while operating in the NLOS mode on network 110. Subsequently, device 150 waits to receive a response from a device 160 on network 120. Once a response is received from the device 160, device 150 sends a message on network 110 notifying devices 180 that device 150 will be absent from network 110 for a predetermined time interval. In such an embodiment, device 150 may enter a sleep mode in network 110 while communicating with device 160 in network 120.

Device 150 will then transition to network 120 and operate as an LOS protocol device while communicating with and servicing device 160. Once completed servicing device 160, device 150 jumps back to network 110 and announces its presence (e.g., awake from sleep state) and begin to communicate with devices 180 using the NLOS protocol.

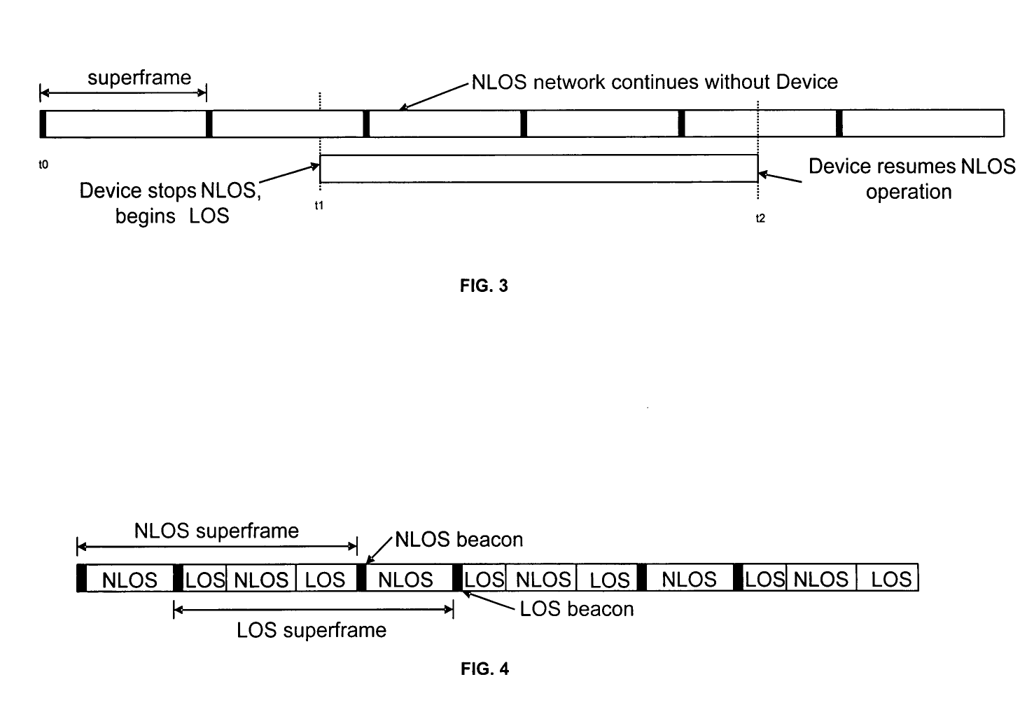

FIG. 3 is a timing diagram illustrating one embodiment of a device 150 communicating with LOS and NLOS networks. At time t0, device 150 is operating in the NLOS network. At time t1, device 150 leaves the NLOS network and begins to communicate with devices in the LOS network, while the NLOS network continues operation without device 150. At time t3, device 150 leaves the LOS network and returns to the NLOS network.

### Time Allocation

According to one embodiment, device 150 communicates with both NLOS protocol devices and LOS protocol devices without leaving either network 110 or network 120. In such an embodiment, combination device 150 reserves time in the NLOS network. During the time reservation in the NLOS network, device 150 operates in the LOS network.

In one embodiment, device 150 controls time in the LOS network by operating the LOS network as a time division multiple access (TDMA) network. In such an embodiment, device 150 arranges communication with an LOS protocol device by transmitting a beacon signal to the LOS device informing the LOS device as to the times at which the LOS device can and cannot transmit data to device 150.

In another embodiment, device 150 enters a polling arrangement with the LOS device where device 150 transmits packets to the LOS device and receives packets from the LOS device in response. In such an embodiment, device 150 constrains the transmissions of the LOS device in time so that the LOS device does not interfere with device 150 operations on the NLOS network.

FIG. 4 is a timing diagram illustrating one embodiment of device 150 communicating with LOS and NLOS networks via a time allocation mechanism. As shown in FIG. 4, device 150 is participating in network 120 and also acting as a controller device in the NLOS network 110. Device 150 reserves time for the operation of LOS network 120 in NLOS network 110 to prevent collisions between communications in the network. Device 150 sends an LOS beacon during the time allocated for the LOS network 120 to assign times for LOS devices in the network to communicate.

In one embodiment, device 150 bridges data between devices on different networks. For example, an LOS device may request to transfer data to a device operating on the NLOS network. Particularly, such a request may be the digital camcorder operating on the LOS network requesting to transmit the data for storage at a DVR on the NLOS network.

In one embodiment, the LOS device transmits the data to device 150 while device 150 operates in the LOS network. Device 150 subsequently transmits the data to an NLOS device once returning to the NLOS network. Thus, the flat panel receives the data from the camcorder and transmits the data to the DVR rather than displaying the data.

The above-described mechanism provides common communication between two network types (e.g. ultra low-power LOS single carrier and streaming NLOS OFDM) and permits minimal change while preserving the advantages of each network architecture.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

What is claimed is:

1. A combination device comprising:
a first radio component to enable the device to communicate with devices in a first wireless network via a first wireless communication protocol; and
a second radio component to enable the device to communicate with devices in a second wireless network via a second wireless communication protocol;
the device to transition from communication with devices in the first network to communicate with devices in the second network at predetermined intervals.

2. The device of claim 1 wherein the device monitors the second network for a message from a device on the second network while operating in the first network.

3. The device of claim 1 wherein the device transmits a beacon signal announcing its presence on the second network while operating in the first network.

4. The device of claim 3 wherein the device waits to receive a response from a device on the second network while operating in the first network.

5. The device of claim 4 wherein the device transitions to the second network upon receiving the response from the device on the second network.

6. The device of claim 4 wherein the device transmits a message signal on the first network notifying devices on the first network that it will be absent for the predetermined interval.

7. The device of claim 6 wherein the device enters a sleep mode in the first network while communicating with the device in the second network.

8. The device of claim 4 wherein the device transitions back to the first network after servicing the device on the second network.

9. The device of claim 1 wherein the first communication protocol is a non line of sight (NLOS) protocol and the second communication protocol is a line of sight (LOS) protocol.

10. The device of claim 1 wherein the device bridges data between devices on the first wireless network and the first wireless network.

11. A combination device comprising:
a first radio component to enable the device to communicate with devices in a first wireless network) via a non line of sight (NLOS) protocol; and
a second radio component to enable the device to communicate with devices in a second wireless network via a line of sight (LOS) protocol;
the device to reserve time in the first network and to communicate with devices in the second network during the time reservation in the first network.

12. The device of claim 11 wherein the device controls time in the LOS network by operating the LOS network by establishing a time division multiple access (TDMA) network.

13. The device of claim 12 wherein the device arranges communication with an LOS device in the second network by transmitting a beacon signal to the LOS device informing the LOS device as to the times at which the LOS device can transmit data to the device.

14. The device of claim 12 wherein the device enters a polling arrangement with an LOS device in the second network by transmitting packets to the LOS device and receiving packets from the LOS device in response.

15. The device of claim 14 wherein the device constrains transmissions of the LOS device in time so that the LOS device does not interfere with device operations on the first network.

16. The device of claim 11 wherein the device bridges data between devices on different networks.

17. A method comprising:
a device communicating with devices in a first wireless network via a first wireless communication protocol;
the device transitioning from operating in the first network to operating in a second wireless network at predetermined intervals; and
the device communicating with devices in the second network via a second wireless communication protocol.

18. The method of claim 17 wherein the device communicates with the first network via a first radio component and communicates with the second network via a second radio component.

19. The method of claim 17 further comprising the device monitoring the second network for a message from a device on the second network while operating in the first network.

20. The method of claim 17 further comprising the device transmitting a beacon signal announcing its presence on the second network while operating in the first network.

21. The method of claim 20 further comprising the device waiting to receive a response from a device on the second network while operating in the first network.

22. The method of claim 21 further comprising the device transitioning to the second network upon receiving the response from the device on the second network.

23. The method of claim 20 further comprising the device transmitting a message signal on the first network notifying devices on the first network that it will be absent for the predetermined interval.

24. The method of claim 23 further comprising the device entering a sleep mode in the first network while communicating with the device in the second network.

25. The method of claim 20 further comprising the device transitioning back to the first network after servicing the device on the second network.

26. A method comprising:
a device communicating with devices in a first wireless network via a first wireless communication protocol;
the device reserving time in the first network; and
the device communicating with devices in a second wireless network via a second wireless communication protocol during the time reservation in the first network.

27. The method of claim 26 wherein the device communicates with the first network via a first radio component and communicates with the second network via a second radio component.

28. The method of claim 26 further comprising the device controlling time in the LOS network by operating the LOS network by establishing a time division multiple access (TDMA) network.

29. The method of claim 28 further comprising the device arranging communication with an LOS device in the second network by transmitting a beacon signal to the LOS device informing the LOS device as to the times at which the LOS device can transmit data to the device.

30. The method of claim 28 further comprising the device entering a polling arrangement with an LOS device in the second network by transmitting packets to the LOS device and receiving packets from the LOS device in response.

31. The device of claim 30 further comprising the device constraining transmissions of the LOS device in time so that the LOS device does not interfere with device operations on the first network.

32. The method of claim 26 further comprising the device bridging data between devices on different networks.
